(19) United States
(12) Patent Application Publication
(10) Pub. No.: US 2007/0296633 A1
(43) Pub. Date: Dec. 27, 2007

(54) System and method for position estimation with high accuracy and a wireless communication terminal device therefor

(75) Inventor: Kentarou Yanagihara, Hyogo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/730,990

(22) Filed: Apr. 5, 2007

(30) Foreign Application Priority Data
Apr. 11, 2006 (JP) 2006-108784

(51) Int. Cl. G01S 3/02

(52) U.S. Cl. 342/463

(57) ABSTRACT

A position estimation system acquires the information used for position estimation from radio signals. The system finds estimated positions of a plural number of radio devices, based at least on the information used for position estimation acquired, the positions of reference terminal devices and the distances by which the radio devices are separated from one another. The system estimates the position of a target terminal device based on estimated positions of plural receiving processors.

### BACKGROUND OF THE INVENTION

1. Field of the Invention

The present invention relates to a system and a method for estimating a position, and, more particularly, to a system and a method for receiving plural electrical waves, transmitted from near-by wireless terminals, and for estimating the position of a desired wireless terminal device with high accuracy based on plural electrical waves received. The present invention also relates to a wireless communication terminal device therefor

2. Description of the Background Art

Japanese patent laid-open publication No. 2004-112482 discloses a conventional method and a system for position detection for a wireless communication terminal device, and a wireless communication apparatus therefor. In the detection method of the conventional position detection system, a base station receives a radio signal, transmitted from a wireless communication terminal device. The base station receives signals transmitted from the terminal device for wireless communication, measures the strength of the received signals, and transmits data on the strength to an information server. The information server receives the strength of the received signals from the base station. Using the information on the strength of the received signals, the base station finds a sphere of possible presence of the terminal device for wireless communication associated with the strength value of the respective received signals. The position of the terminal device for wireless communication is detected from overlap of the spheres thus found.

U.S. Pat. No. 6,473,038 to Patwari et al., discloses a method and an apparatus for location estimation, which measures a signal transmitted between a device with a known position and another device with an unknown position and a signal transmitted between a set of devices with unknown devices. This method uses a plural number of first sub-equations. Measured signals are entered into a graphic function, including a plural number of sub-equations for signal measurement and estimation having an extreme value which appears when the signal of predictive measurement are equal to actual measured values. The graphic function is then optimized to search for the position of the respective devices.

Both proposals may be summarized as follows: The proposed methods use radio signals to estimate the position of a wireless terminal device of a mobile terminal. The system includes a target terminal device as a subject of position estimation and a reference terminal device the position of which is known from the outset. Depending on the type of a signal transmitting system, there is added to the system a server for estimating the position of a target terminal device. In the operation of this system, a radio signal is transmitted between the reference terminal device and the target terminal device. Measured values which are obtained on the transmission and reception of the radio signals and may be used for estimating the positional relationships between the terminal devices, such as distances or angles or for estimating the information are integrated, by some communication means or other, in a position estimator of the target terminal device or the server for position estimation. The position estimator executes an algorithm, based on the so integrated information, to estimate the most probable position of the target terminal device.

However, the environment of a wireless propagation path may be varied due to reflection and diffraction or the movement of people therearound, even without movement of a target terminal device. Consequently, the measured values, used for estimating, e.g. the distance, may be varied appreciably, even in the absence of movement of target terminal devices. For these reasons, the position estimation system, exploiting radio signals, are poor in estimation accuracy.

In technical reports of The Journal of the Institute of Electronics, Information and Communication Engineers (JEICE) or lectures delivered in the Academic Societies, there have been proposed a large variety of position estimation methods. Among specified examples of the treatises of the Academic Societies, there are D. Zhao et al., “A Maximum Likelihood Estimation Method of Localization Using RSSI in Wireless Sensor Networks”, IN, Vol. 327, pp. 409-414, (2004), and M. Takashima et al., “An Experiment of Indoor Location Estimation Using IEEE 802.15.4”, SN, Vol. 5, pp. 33-38 (2005). Among specified examples of treatises by the lectures, delivered in the academic meetings, there is a treatise by D. Zhao et al., entitled “A Method for reducing Location Estimation Data Traffic in Sensor Networks”, A-21-20, and a treatise by M. Takashima et al., “An Experiment on Indoor Location Estimation Using IEEE.802.15.4—Effect by Pedestrians and RF Sensitivities—”, A-21-22, in 2005 Electronic Information Communication Society Base Boundary Society Meeting.

In summary, these were proposals for a system in which a wireless propagation environment is modeled by a probabilistic model to effect position estimation as the aforementioned problems are taken into account. In these proposals, a target terminal device transmits a signal and, when the reference terminal device receives a signal transmitted from the target terminal device, the reference terminal device transmits the information on the strength of a received signal to a server for position estimation. The server then estimates the most probable position of each target terminal device, using the strength of the received signal transmitted from the target terminal device.

However, with the above position estimation systems, the number of reference terminal devices installed is increased with increase in a target area for position estimation. If a larger number of reference terminal devices is installed in this manner, the system cost is increased. In addition, depending on the environment in which the terminal devices are set, it may not physically be possible to install many reference target devices. Moreover, in order to improve position estimation accuracy, it may be required of the position estimation system to install and use a larger number of reference terminal devices so that the position estimator may be required to collect a lot of information. If the number of the reference terminal devices is increased that much, the amount of communication used for position estimation by the position estimation system is increased. However, such an increase in amount of communication is likely to deteriorate the communication quality.

### SUMMARY OF THE INVENTION

It is an object of the present invention to provide a system and a method position estimation, and a wireless communication terminal device capable of minimizing the problem that the amount of communication is increased with increase in the range for position estimation and decreasing the number of the reference terminal device, thus assuring position estimation of high accuracy.

In accordance with the present invention, there is provide a method for position estimation for estimating the position of a plurality of target terminal devices, in a wireless network including a plurality of reference terminal devices and the target terminal devices. Each target terminal device is a subject for position estimation and has the function of wireless communication, while each reference terminal device has the function of wireless communication and has its installed position known. The method comprises a first step of transmitting the information on the installed position from each of the reference terminal devices, and a second step of receiving a radio signal from each of the reference terminal devices, by the target terminal devices, and acquiring the information used for position estimation from the radio signal. The method also comprises a third step of estimating the position of the target terminal devices based on the information for position estimation acquired in the target terminal devices, the position information of the reference terminal devices and the distance information on the distance by which a plurality of wireless devices owned by each of the target terminal devices are separated from one another.

In accordance with the present invention, there is also provided a method for position estimation for estimating the position of a plurality of target terminal devices, in a wireless network including a plurality of reference terminal devices and the target terminal devices. Each target terminal device is a subject for position estimation and has the function of wireless communication, while each reference terminal device has the function of wireless communication and has its installed position known. The method comprises a first step of transmitting the information from each of the target terminal devices, and a second step of receiving the information from the target terminal devices at each of the reference terminal devices, and transmitting a radio signal, including the information generated responsive to the received information, from each of the reference terminal devices to the target terminal devices. The method also comprises a third step of estimating the position of the target terminal devices, based on the information for position estimation acquired from the radio signal received by the target terminal devices, the position of the reference terminal devices and the distance information on the distance by which a plurality of radio devices owned by the target terminal devices are separated from one another.

With the method for position estimation, according to the present invention, the information used for position estimation is acquired from the radio signal, and an estimated position of each of a plural number of terminal devices for wireless communication is found based at least on the acquired information used for position estimation, the position of the reference terminal devices and on the distance by which the radio devices are separated from one another. The position of the target terminal device is estimated based on the estimated position of the terminal devices for wireless communication. By so doing, position estimation in the target terminal device may be improved in accuracy without increasing the number of the reference terminal devices.

In accordance with the present invention, there is also provided a position estimation system comprising a target terminal device having a plurality of radio devices, the distance of which from one another is known, a plurality of reference terminal devices arranged at known positions, and a position estimator. The reference terminal devices transmit and receive a radio signal to and from the target terminal device. The position estimator estimates the position of the target terminal device, based on the radio signal, the position of the reference terminal devices and the distance by which the radio devices are separated from one another. The position estimator acquires the information for position estimation from the radio signal, and finds estimated position of the radio devices based at least on the information for position estimation acquired, the position of the reference terminal devices and on the positional relationships of the radio devices inclusive of distance by which the radio devices are separated from one another. The position estimator estimates the position of the target terminal device based on estimated position of the radio devices.

In accordance with the present invention, there is also provided a position estimation system comprising a target terminal device having a plurality of radio devices, the distance of which from one another is known, a plurality of reference terminal devices arranged at known positions, and a position estimator. The reference terminal devices transmit and receive a radio signal to and from the target terminal device. The position estimator estimates the position of the target terminal device, based on the radio signal, the position of the reference terminal devices, and the distances by which the radio devices are separated from one another. The position estimator acquires the information for position estimation from the radio signal, and finds the first estimated position information in each radio device based at least on the information for position estimation acquired and the position of the reference terminal devices. The position estimator also finds the second estimated position information in the radio devices based at least on the first estimated position information in each radio device, the distance by which the radio devices are separated from one another, the information for position estimation, acquired form the radio signal, and the position of the reference terminal devices. The position estimator estimates the position of the target terminal device based on the second estimated position information in the radio devices.

With the position estimation system according to the present invention, the position estimator acquires the information for position estimation from the radio signal and finds the first estimated position information in each radio device based at least on the information for position estimation acquired and on the position of the reference terminal devices. The position estimator then finds the second estimated position information in the radio devices based at least on the first estimated position information in each radio device, the distance by which the radio devices are separated from one another, the information for position estimation, acquired form the radio signal, and the position of the reference terminal devices. The position estimator then estimates the position of the target terminal device based on the second estimated position information in the radio devices. By so doing, position estimation in the target terminal device may be improved in accuracy without increasing the number of the reference terminal devices.

### BRIEF DESCRIPTION OF THE DRAWINGS

The objects and features of the present invention will become more apparent from consideration of the following detailed description taken in conjunction with the accompanying drawings in which:

FIG. 1 is a schematic diagram showing an arrangement of a position estimation system according to an embodiment of the present invention;

FIG. 2 is a schematic block diagram showing the configuration of a reference terminal device shown in FIG. 1;

FIG. 3 is a schematic block diagram showing the configuration of a target terminal device shown in FIG. 1;

FIG. 4 is a flowchart useful for understanding the sequence of position estimation of a target terminal device in a position estimation system according to the present invention;

FIG. 5 is a flowchart useful for understanding a modified operation for position estimation of a target terminal device in the position estimation system according to the present invention;

FIG. 6 is a schematic diagram showing the positional relationship between a reference and a supplementary antenna in a position estimation system according to the present invention;

FIG. 7 is a schematic diagram showing an arrangement of an alternative embodiment of a position estimation system according to the present invention;

FIG. 8 is a schematic block diagram showing the configuration of a target terminal device shown in FIG. 7;

FIG. 9 is a schematic block diagram showing the configuration of a reference terminal device shown in FIG. 7;

FIG. 10 is a block diagram schematically showing an alternative embodiment of a target terminal device in a position estimation system according to the present invention;

FIG. 11 is a schematic diagram showing an arrangement of another alternative embodiment of a position estimation system according to the present invention;

FIG. 12 is a schematic block diagram showing the configuration of a target terminal device shown in FIG. 11;

FIG. 13 is a flowchart useful for understanding a sequence of position estimation of a target terminal device in a position estimation system according to the present invention;

FIG. 14 is a flowchart useful for understanding the sequence following sequence of position estimation in FIG. 13; and

FIGS. 15 and 16 is a flowchart useful for understanding another sequence of position estimation of a target terminal device in a position estimation system according to the present invention.

### DESCRIPTION OF THE PREFERRED EMBODIMENTS

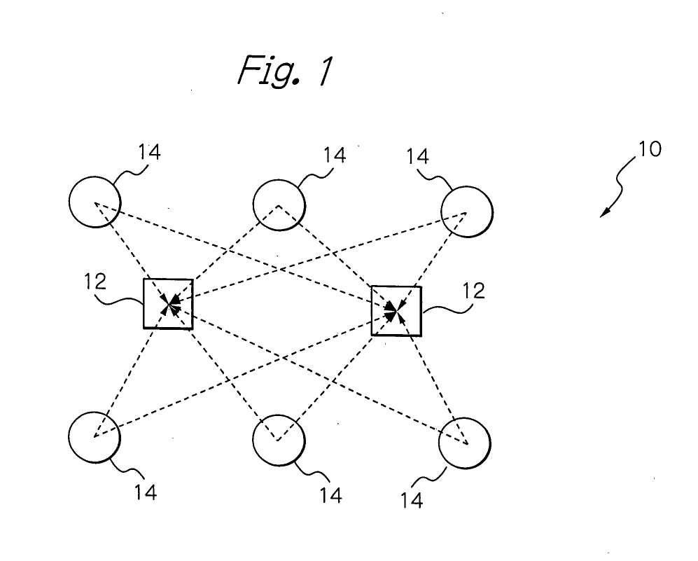

Referring to the accompanying drawings, an embodiment of the position estimation system according to the present invention will be described in detail. With reference first to FIG. 1, a preferred embodiment of a position estimation system 10 according to the present invention includes a plural number of target terminal devices 12 and a plural number of reference terminal devices 14. Each target terminal device 12 includes a plural number of radio devices, not shown, spaced apart by known distances from one another. The reference terminal devices 14 are arranged at known positions and are adapted to transmit and receive radio signals to and from the target terminal devices 12.

Although not shown, each target terminal device 12 includes a position estimator adapted for estimating the position of the target terminal device 12, based on the radio signals, the positions of the reference terminal devices 14 and the distances by which the radio devices are separated from one another. The position estimator acquires the information for estimating the positions of the target terminal devices 12, based on the radio signals, and finds an estimated position of each of a plural number of the radio devices, based at least on the acquired information, used for position estimation, the positions of the reference terminal devices 14 and on the positional relationship of the radio devices, inclusive of the information on the distances by which the radio devices are separated from one another. The position estimator then estimates the position of the target terminal device 12, based on the estimated positions of the radio devices. In this manner, position estimation by the target terminal device 12 may be improved in accuracy without increasing the number of the reference terminal devices 14. Parts or components not directly relevant to understanding the present invention are not shown nor described.

Referring to FIG. 1, the position estimation system 10 includes two target terminal devices 12 and several reference terminal devices 14. The target terminal device 12 is a terminal device the position of which is to be estimated. The target terminal device 12 has the function of receiving a position estimation request signal, defined later herein, measuring the signal power of the received position estimation request signal, and estimating the own position based on measured results. In FIG. 1, broken lines indicate that no counterpart of transmission is specified and that transmission is directed to all surrounding terminals, that is, the transmission is broadcast, while a solid line indicates that transmission is directed to the terminal device as pointed by an arrow attached to the solid line, that is, the transmission is unicast. The reference terminal device 14 is a terminal device, the position of which is known from the outset, and has the function of transmitting the position estimation request signal, which is a signal for position estimation.

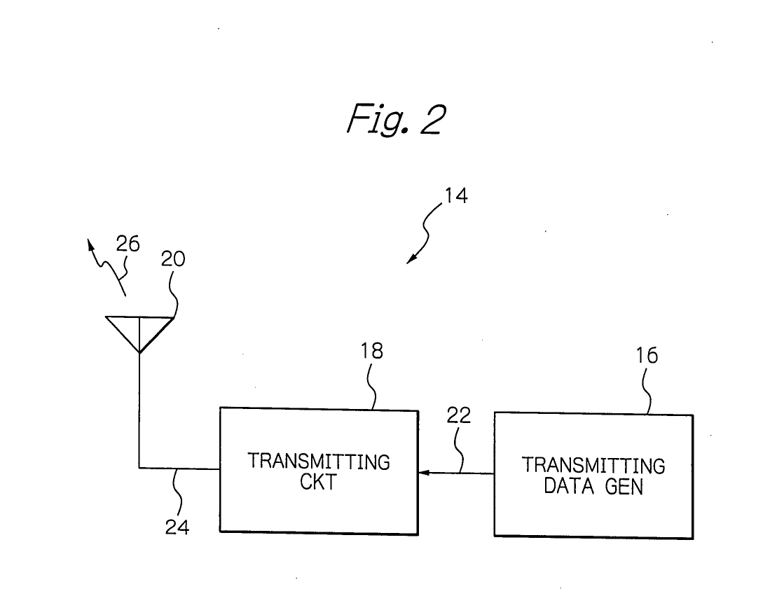

Initially, the configuration of the reference terminal device 14 will be described. Referring to FIG. 2, the reference terminal device 14 includes a transmitting data generator 16, a transmitting circuit 18 and an antenna 20, which are interconnected as illustrated. The transmitting data generator 16 has the function of generating a position estimation request signal 22, inclusive of an identification code proper to the reference terminal device 14, and transmits the position estimation request signal 22 generated to the transmitting circuit 18. In the following description, signals are denoted by reference numerals of connection lines on which appear the signals. The transmitting circuit 18 has the function of converting the position estimation request signal 22, generated by the transmitting data generator 16, into a radio signal 24, and transmits the so generated radio signal 24 to the antenna 20, which is adapted for radiating a radio wave signal 26. The reference terminal device 14 transmits the radio signal 24, supplied thereto, from the antenna 20 in the form of electro-magnetic wave for transmission 26.

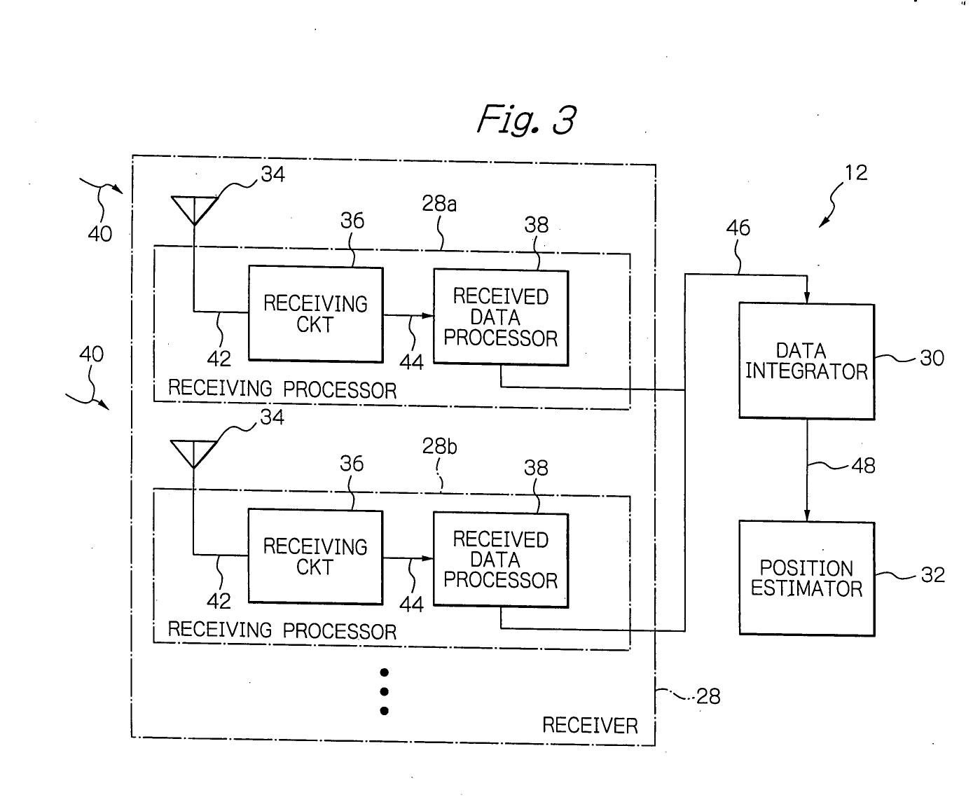

The configuration of the target terminal device 12 will now be described. Referring to FIG. 3, the target terminal device 12 includes a receiver 28, a data integrator 30 and a position estimator 32, which are interconnected as shown. The receiver 28 includes a plural number of receiving processors 28a, 28b, . . . Each of the receiving processors 28a, 28b, . . . includes basically the same components, that is, an antenna 34, a receiving circuit 36 and a received data processor 38, which are interconnected as depicted. The antenna 34 receives a radio signal 40. The receiving circuit 36 has the function of receiving the radio signal 40, received by the antenna 34, and converting a signal, obtained on frequency selection of a received signal 42, into the corresponding digital information. The receiving circuit 36 outputs the digital information, obtained on the conversion, to the received data processor 38 as received data 44. The receiving circuit 36 has the function of measuring a value of the received power S1 of the received radio signal 42, and outputs the information on the value of the received power S1 to the received data processor 38 in the form of information 44 used for position estimation. The received data processor 38 has the function of processing the received data 44 received from the receiving circuit 36. In case the received data 44 is a position estimation request signal 26, transmitted from the reference terminal device 14, the received data processor 38 processes the information contained in the position estimation request signal 26, the information on the value of the received power S1 as measured by the receiving circuit 36, and the information including an identification code proper to the reference terminal device, by the information processing function proper to the processor, to develop processed data 46, which is then output to the data integrator 30.

The data integrator 30 has the function of integrating, i.e. collecting, the information 46 supplied from the plural receiving processors 28a, 28b, . . . . The data integrator 30 outputs the so integrated or collected information 48 to the position estimator 32. The position estimator 32 has the function of estimating the position of the target terminal device 12, based on the plural information 48 received from the data integrator 30, by the processing which will be described subsequently. Known are the positional relationships between the antennas 34 of the receiving processors 28a, 28b, . . . , corresponding to the distances by which the radio devices are separated from one another. As the known positional relationships, use may be made of information on the distances by which the antennas 34 are separated from one another and are available when installing the target terminal device 12.

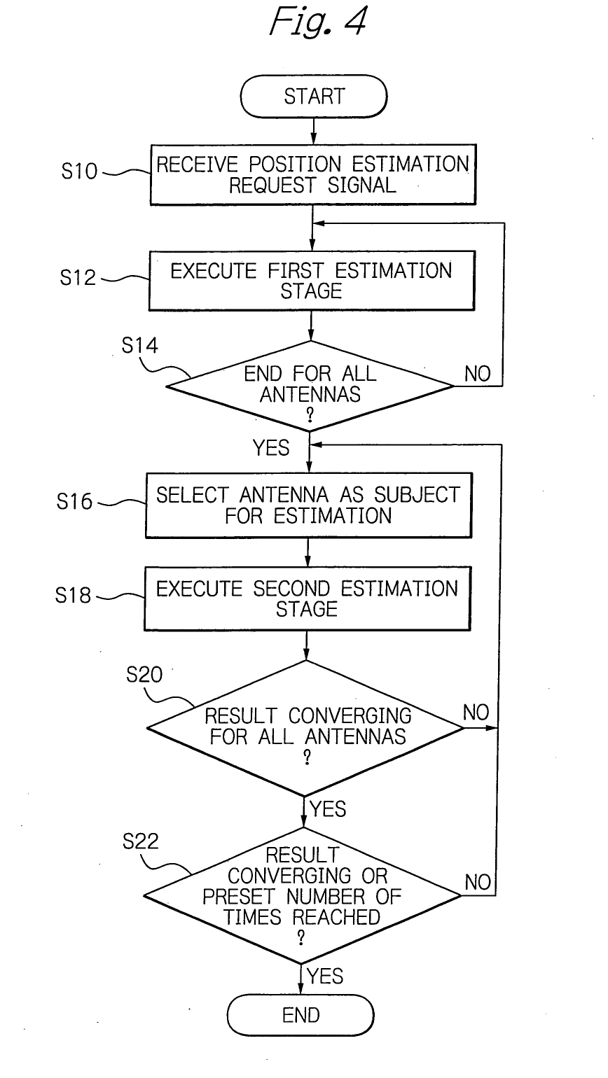

The operational sequence of position estimation of the target terminal device 12 in the position estimation system 10 of FIG. 1 will now be described with reference to the flowchart of FIG. 4. First, each of the reference terminal devices 14 converts the position estimation request signal 22, inclusive of an identification code proper to each of the reference terminal devices 14, i.e. code of transmitting terminals, into the radio signal 24, which is then transmitted from the antenna 20 as a radio signal 26.

The receiving processors 28a, 28b, . . . of the receiver 28 of the target terminal device 12 receive the electrical wave 40, transmitted from the reference terminal devices 14, and measure the received power S1 of the position estimation request signal contained in the radio signal 42 received. The receiving processors output to the data integrator 30 the information 46 including the information of the measured value of the received power S1, the information of the codes of transmitting terminals or the identification code of the receiving target terminal device 12 (step S10). The data integrator 30 collects the information 46, received from the receiving processors 28a, 28b, . . . , and outputs the so collected information 48 to the position estimator 32.

The position estimator 32 then executes a first estimation stage (step S12). The position estimator 32 sets the positions of the antennas 34 of the receiving processors 28a, 28b, . . . , as the estimated positions of the receiving processors 28a, 28b, . . . , based on the information output from the data integrator 30, by way of finding the first estimated positions. The first estimation stage is the procedure of finding the first estimated positions. The positions of the antennas 34 are estimated by the receiving processors 28a, 28b, . . . in such a manner, for example, that the information transmitted between the reference terminal devices 14 and the receiving processors 28a, 28b, . . . of the target terminal device 12 and the positions of the reference terminal devices 14 are used to calculate the presence probability in each of the locations where the presence of one of the antennas 34 is presumed by the respective receiving processors 28a, 28b, . . . .

The position estimator 32 then searches for a point of the highest presence probability of the antenna 34, using, e.g. the technique of the maximum likelihood method, to set the point thus found as an estimated position of the antenna 34. The position estimator 32 also refers to a table defining the relationship between the value of the received power S1 and the distance, and finds the distances between the one antenna 34 in each of the receiving processors 28a, 28b, . . . and the respective reference terminal devices 14, the positions of which are known from the outset, to find the estimated position.

Meanwhile, the above-described method for acquiring the estimated position is not restrictive but the estimated position may be found by methods other than the method described above.

It is then determined whether or not the operation of position estimation of all of the antennas 34 in the receiving processors 28a, 28b, . . . has been finished (step S14). If the position estimation has not as yet been finished (NO), the position estimator 32 reverts to execution of the first estimation stage (to step S12). If the position estimation has been finished (YES), the position estimator 32 proceeds to antenna selecting processing (to step S16).

The processing for antenna selection then selects the first estimated position in each of the receiving processors 28a, 28b, . . . , found by the first estimation stage (step S16).

The position estimator 32 then executes a second estimation stage (step S18). The second estimation stage is the processing of setting the position of the antenna 34, selected in the receiving processors 28a, 28b, . . . , as an estimated position of the selected receiving processor, based on the first estimated position, as selected, and on the positional relationships of the respective antennas 34. In the second estimation stage, the antennas other than the selected antenna 34 are assumed to be at the first estimated position thus found. The position of the selected antenna 34 is estimated based on this assumption.

In the second estimation stage, a point of the highest presence probability of the antenna 34 of the selected receiving processor is searched for, based on the information transmitted between each of the reference terminal devices 14 and the selected receiving processor of the target terminal device 12, the positions of the reference terminal devices 14, the first estimated positions of the antennas 34 of the other receiving processors of the target terminal device 12 and on the information of the distances by which the respective antennas 34 are separated from one another. The point obtained on this search is set as an estimated position of the selected receiving processor.

A specified method for position estimation will now be described. Initially, the estimated position of another receiving processor of the target terminal device 12 is set as a center coordinate. Second, a circle is drawn which has its center coincide with the center coordinate and its radius equal to the distance between the selected receiving processor and the other receiving processor. Third, the presence probability of the selected receiving processor at each point on the circumference of the circle is found and the point of the highest presence probability is set as an estimated position of the selected receiving processor.

However, there is a probability of the calculations for position estimation not converging due to an error in position estimation of the other receiving processor in the target terminal device 12. In this case, not the circumference but a perimeter of a doughnut shape obtained on affording a width to the radial size may be used for finding the point of the highest presence probability. The above-described method for acquiring the estimated position is not restrictive but other suitable methods may also be used to find the estimated position. The second estimated position thus found is corrupted with estimation error only to a less extent than the estimated position as found in the first estimation stage. It is because the information the receiving processors are separated from one another is used.

It is then checked whether or not the second estimation stage is finished for all of the receiving processors of the target terminal device 12 (step S20). If the processing of the second estimation stage is not finished for all of the antennas (NO), processing reverts to the step of selecting the antenna for selection (to step S16). If the processing of the second estimation stage is finished for all of the antennas (YES), processing transfers to a processing of the decision step (to step S22).

The decision for processing end is given depending on whether or not the result of position estimation has converged or whether or not the limit on calculating time has been reached (step S22). The reason for giving this decision will now be described briefly. The estimated position of the selected receiving processor is changed from the first estimated position to the second estimated position as a result of carrying out the second estimation stage. Since the estimated position of the selected receiving processor is used for position estimation of the other receiving processors, the change in the estimated position of the selected receiving processor affects position estimation in the other receiving processors. Thus, in case of change in the estimated position of the selected receiving processor, the positions of the other receiving processors are again estimated. Specifically, the second estimation stage is carried out for all of the receiving processors other than the selected receiving processor as the second estimated position is used as the first estimated position. In case the result of position estimation has converged or if the limit of calculating time, for example, the preset number of times of repetition, is reached (YES), processing transfers to an end step so that processing comes to a close. In case of non-convergence or in case the preset number of times of repetition has not been reached (NO), processing transfers to a step for antenna selection (step S22).

However, if the processing steps (steps S16 to S22) are repeated, it is highly probable that the results of position estimation do not converge because of interference of update events of the two position estimation operations.

Thus, for updating the estimated position, the position estimator 32 has the function of comparing the estimated position newly obtained to the estimated position obtained in the past to correct the estimated position as necessary. For example, if the post-update estimated position differs appreciably from the pre-update estimated position, a position on a line segment interconnecting the post-update estimated position and the pre-update estimated position is set as the post-update estimated position. It is also possible for the position estimator 32 to record the past estimated positions and to discontinue the processing in case the post-update estimated position is coincident with the past estimated position.

It is also possible for the data integrator 30 to exploit the difference in the information obtained in the receiving processors 28a, 28b, . . . , by taking advantage of the feature of these receiving processors 28a, 28b, . . . simultaneously receiving the same signal. In case the difference in the information obtained exceeds a preset value, the data with small value of the received power S1 may be determined as being low in reliability and hence may be discarded.

In estimating the position, the position estimator 32 may also use the information obtained in the past. That is, the received data processor 38 and the position estimator 32 for the receiving processor may include the function of measuring the time and holding the time of data acquisition, so that, when the position estimator 32 exploits past data for position estimation, the weight afforded to the past data may be varied depending on the time elapsed until the current time. The reason for doing this is that the past data are presumably lower in reliability than the current data and hence the older the data, the lower is to be the weight afforded to the data. As a specified technique, past data may be multiplied with a weight equal to a reciprocal of the difference between the time of the past data and that of the current data.

The target terminal device 12, including the aforementioned time measuring function and the time retention function, described above, may further include a movement detector, not shown, having the function of detecting the movement of the terminal device. In this case, the target terminal device 12, employing the past information, may change the weight afforded to the past information depending on whether or not the target terminal device has performed movement and on the amount of movement in case the target terminal device has performed the movement.

Moreover, it is possible for the received data processor 38 to hold, e.g. the past information and to verify the information obtained so that data of low reliability will not be notified to the data integrator 30. By so doing, it is possible with the target terminal device 12 to improve the accuracy in position estimation.

In this manner, out of the information received by the receiving processors 28a, 28b, . . . of the target terminal device 12, the results of position estimation of the receiving processors 28a, 28b, . . . , not selected by the position estimator 32, may be exploited in the iterative estimation, whereby it is possible to realize position estimation to higher accuracy and to prevent the amount of communication from increasing even under an environment with a smaller number of the reference terminal devices 14.

On the other hand, in case the positional relationships of the receiving processors 28a, 28b, . . . in the target terminal device 12 are fixed, it is possible with the target terminal device 12 to detect the direction of movement as well as rotation of the target terminal device 12, as a result of estimation of the positions of the receiving processors 28a, 28b, . . . . Specifically, the orientation of the mobile terminal or the bodily orientation of the person carrying the terminal may be detected depending on whether the receivers are mounted on the right or left side of the mobile terminal or on whether the user attaches the mobile terminal on the left side or the right side of his/her spectacles, helmet or apparel.

The present invention is not limited to an embodiment in which the position estimator 32 is enclosed within the target terminal device 12. For example, the position estimator 32 may be disposed separately from the target terminal device 12 and arranged as a separate communication device between the data integrator 30 and the position estimating device for transmitting and receiving data used for position estimation. By so doing, position estimation of a plural number of target terminal devices 12 becomes possible with the use of the sole position estimating device.

According to the present invention, it is unnecessary for the same device to measure the received power or to output identification codes in the receiving processors 28a, 28b, . . . . Instead, these operations may be performed by a separate device mounted outside the device.

An alternative embodiment of the position estimation system according to the present invention will now be described. Parts or components like those of the embodiment described above are denoted with the same reference numerals and will not repetitively be described for avoiding the redundancy. The position estimation system 10 of the present alternative embodiment is basically the same as the system of the previous embodiment, with the exception that the positions of each of the antennas 34 of the target terminal device 12 are not determined and that optional one of the antennas 34 is set as a reference antenna and the positions of the remaining antennas 34 are estimated based on the relative positions thereof from the reference antenna.

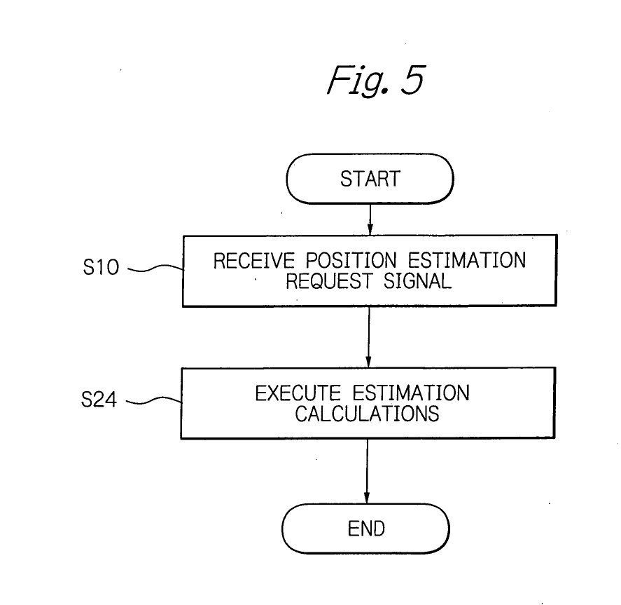

The operation of position estimation by the target terminal device 12 of the position estimation system according to the present invention will now be described with reference to FIG. 5. The steps similar to those of the previous embodiment are denoted by the same reference numerals. Each of the receiving processors 28a, 28b, . . . of the target terminal device 12 receives the position estimation request signals, transmitted from the reference terminal devices 14, and measures the values of the received power S1 of the position estimation request signals received. Each of the receiving processors outputs the information of the values of the received power S1, as measured, the information of the codes of transmitting terminals and the information of the identification codes of the receiving processors of the target terminal device 12 in their entirety to the data integrator 30 (step S10). The data integrator 30 collects the information received from each of the receiving processors 28a, 28b, . . . to output the so collected information to the position estimator 32.

The position estimator 32 executes calculations for estimation in order to find the estimated positions of the receiving processors 28a, 28b, . . . based on the information received from the data integrator 30 (step S24). The position estimator 32 of the instant alternative embodiment sets one of the plural antennas 34 of the target terminal device 12, as a reference antenna. The remaining antennas 34 are provided with the function of generating the information on the distances from the reference antenna.

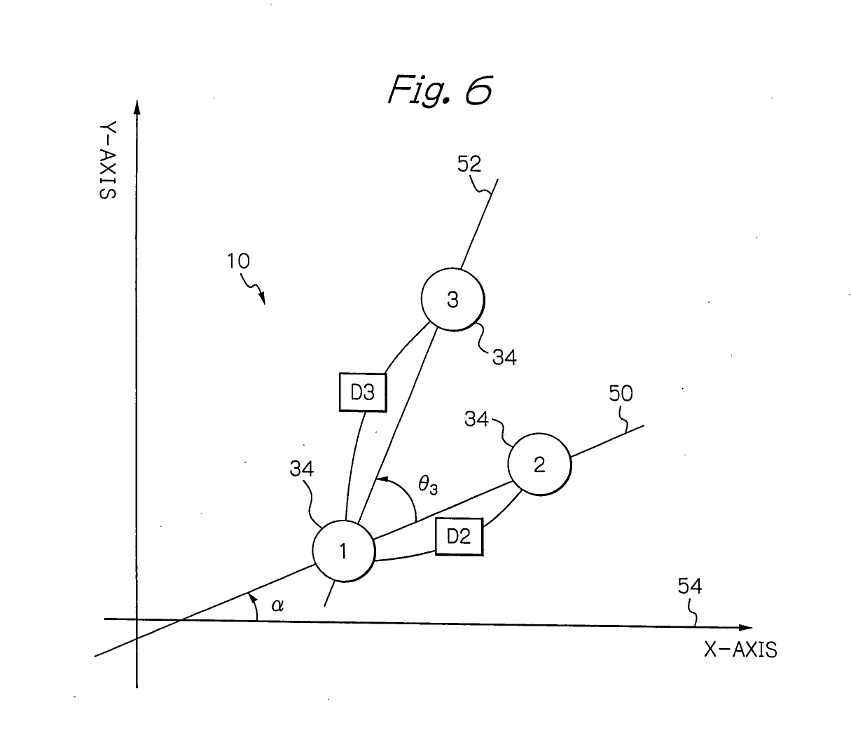

In case the target terminal device 12 has three or more antennas 34, as shown in FIG. 6, the position estimator also has the information on an angle θ₃ between a line segment 50 interconnecting a first antenna as set as a reference antenna and a second antenna and a line segment 52 interconnecting the first antenna and a third antenna. By this additional information, the positions of the antennas 34 other than the reference antenna may be represented by an angle α between the line segment 50 interconnecting the first antenna and the second antenna and the reference coordinate axis 52. With the use of this notation, it is possible with the position estimator 32 to perform position estimation, without iterative calculations, in performing position estimation from the information obtained from the plural antennas 34, as described subsequently.

Taking an example of position estimation on a two-dimensional surface, the usual estimation of the previous embodiment assumes a point of the maximum value of the position estimation function on the two-dimensional surface as an estimated position. The present alternative embodiment finds a point of the maximum value of the function of position estimation using three parameters, namely position parameters x, y indicating the positions of the antennas 34 and an angular parameter α that the line segment 50 interconnecting the first antenna and the second antenna makes with the reference line 54 of the surface for position estimation. Hence, the result as found represents positions of the highest presence probability of all antennas given the information obtained from all of the antennas and the constraint conditions.

A specified example of position estimation, exploiting the information on the relative positions from the reference antenna, will now be described. In the position estimation by the receiving processors 28a, 28b, . . . , the estimated positions of the antennas 34 in the receiving processors 28a, 28b, . . . , are found, based on the information on the values of the received power S1 of the position estimation request signals, received by the selected receiving processor, codes of transmitting terminals, positions of the reference terminal devices 14, distances by which the antennas are separated from one another and the angles the antennas make with other antennas. In case there are provided three or more antennas, an angle θᵢ between line segments 50 and 52 and an angular parameter α are defined. The line segment 50 is obtained on interconnecting a first antenna set as the reference antenna 34 and a second antenna set as additional antenna 34, and the line segment 52 is obtained on interconnecting the first antenna 34 and a third or a further following additional antenna 34. The distance between the reference antenna and an i-th antenna is set as Dᵢ. The suffix i in the angle θᵢ is an integer not less than two. Also, from definition, it is evident that θ₂ is zero. If the estimated position of the reference antenna is set as (x, y), the estimated positions of the second and the following antennas are given by
(x+Dᵢ sin(α+θᵢ), (y+Dᵢ cos(α+θᵢ)),
where the angle α is defined between a line segment interconnecting the first and second antennas and the x-axis of the position estimation coordinate system or a line segment 54. The angle α indicates rotation of the position estimation system 10 in its entirety. If once the three parameters x, y and α are determined, the positions of the antennas are determined in their entirety.

If the estimated position of the reference antenna x, y and the angle of rotation α are supposed, the positions of the antennas 34 may be determined in their entirety. The position estimator 32 then calculates the presence probability of the target terminal device 12 at the supposed parameters x, y and α, based on the information transmitted between the reference terminal devices 14 and the receiving processors 28a, 28b, . . . of the target terminal device 12 and on the positions of the reference terminal devices 14.

The position estimator 32 searches for a parameter (x, y, α), which will bring about the maximum value of the presence probability of the target terminal device 12, using the technique of the maximum likelihood method, as an example. The position estimator 32 sets (x, y) of the so obtained parameter as an estimated position for the target terminal device 12.

Thus, with the present alternative embodiment, the positions of the antennas in their entirety may be estimated, based on the information on the positions of the respective antennas 34 of each of the receiving processors, 28a, 28b, . . . . This allows for a shorter calculating time for position estimation, without the necessity of repeated calculations involved in the position estimation, to add to the favorable effect derived from the previous embodiment shown in and described with reference to FIG. 3.

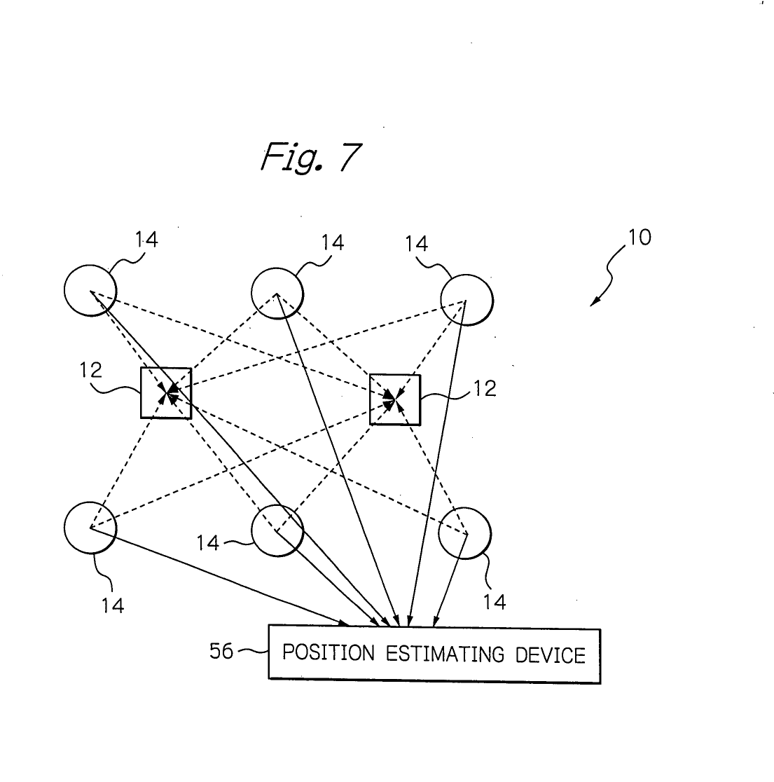

A further alternative embodiment of the position estimation system according to the present invention will now be described with reference to FIGS. 7, 8 and 9. As seen from FIG. 7, the position estimation system 10 of the instant alternative embodiment includes a position estimating device 56, in addition to the target terminal devices 12 and the reference terminal devices 14.

Each target terminal device 12 is a target of position estimation and transmits a position estimation request signal. Each reference terminal device 14 is a terminal device the installed position of which is known from the outset. On receipt of the position estimation request signal, the reference terminal device 14 transmits the information usable for position estimation, as a position estimation information signal. The position estimating device 56 estimates the respective positions of the transmitting processors, from the position estimation information signals collected, and ultimately estimates the positions of the target terminal devices 12.

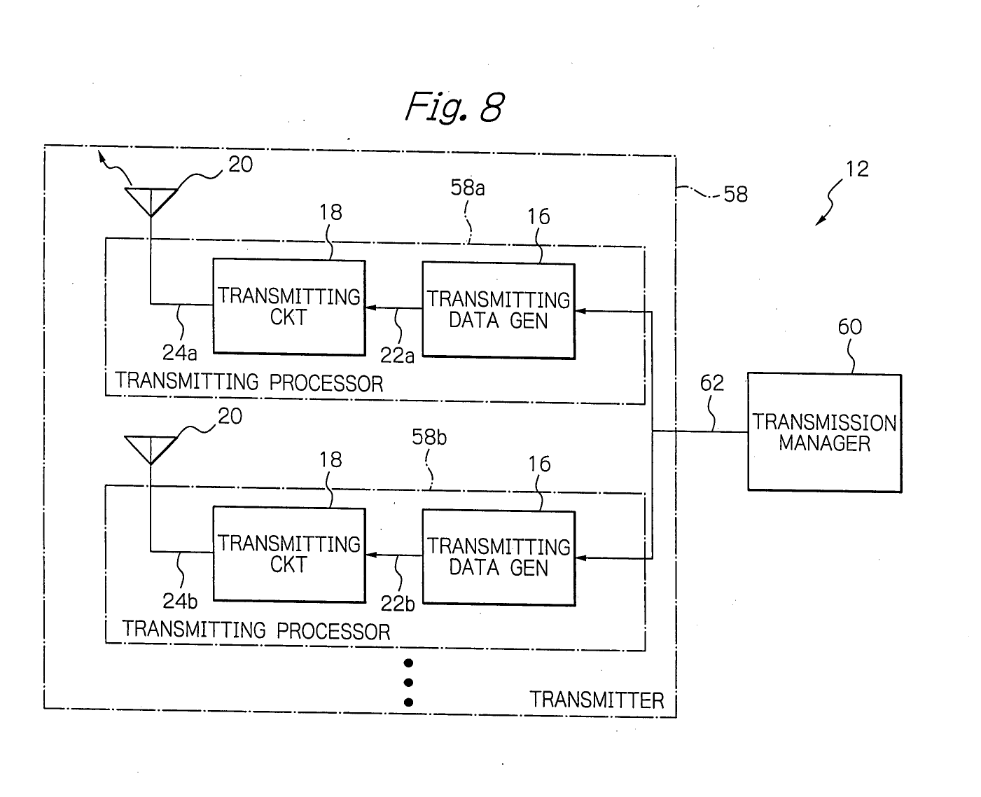

Referring to FIG. 8, the target terminal device 12 includes a transmitter 58 and a transmission manager 60, which are interconnected as illustrated. The transmitter 58 includes a plural number of transmitting processors 58a, 58b, . . . .

Each of the transmitting processors 58a, 58b, . . . basically includes a transmitting data generator 16, a transmitting circuit 18 and an antenna 20, which are interconnected as illustrated. The transmission manager 60 has the function of averting the interference of the signals 24a, 24b, . . . transmitted from the transmitting processors 58a, 58b, . . . of the transmitter 58, and the function of outputting a command for transmission 62 for transmitting a position estimation request signal to each of the transmitting processors 58a, 58b, . . . , as processing delay caused in the reference terminal devices 14 is taken into account.

Upon receipt of instructions from the transmission manager 60, the transmitting data generators 16 of the transmitting processors 58a, 58b, . . . generate position estimation request signals 22a, 22b, . . . , inclusive of an identification code proper to the target terminal device 12 and the identification codes proper to the transmitting processors 58a, 58b, . . . , to output the so generated position estimation request signals to the transmitting circuits 18. The transmitting circuits 18 each convert the position estimation request signals 22a, 22b, . . . , generated in the transmitting data generators 16, into the radio signals 24a, 24b, . . . , to output the so generated radio signals at the antennas 20. The antennas 20 transmit the radio signals 24a, 24b, . . . .

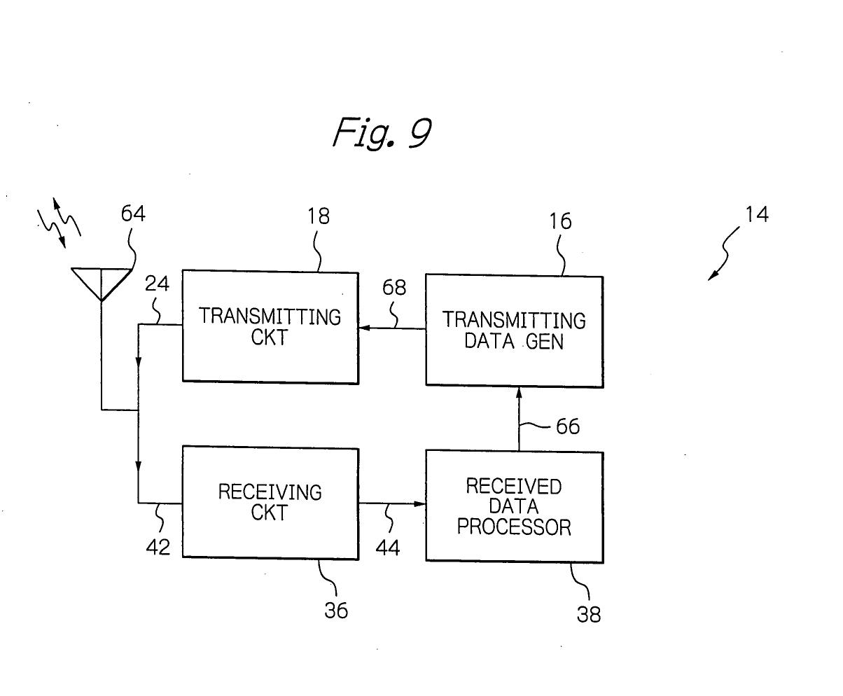

Referring to FIG. 9, the reference terminal device 14 includes a transmitter/receiver antenna 64, a receiving circuit 36, a received data processor 38, a transmitting data generator 16 and a transmitting circuit 18, which are interconnected as shown. The transmitter/receiver antenna 64 receives electrical waves and transmits a received signal 42 to the receiving circuit 36, which receiving circuit 36 measures the value of the received power S1 to send received data 44 to the received data processor 38. The received data processor 38 processes the received data 44 sent from the receiving circuit 36. The processing carried out by the received data processor 38 is such that, in case the received data 44 is the position estimation request signal sent from the target terminal device 12, the data which instructs the transmitting data generator 16 to generate transmitting data is supplied as information command data 66 to the transmitting data generator 16. The transmitting data is data including the information on the value of the received power S1, as measured by the receiving circuit 36, the identification code proper to the target terminal device 12 included in the position estimation request signal, and transmitting data proper to the transmitting/processing units 58a, 58b, . . . .

The transmitting data generator 16 produces a position estimation information signal 68, based on the information command data 66. The position estimation information signal 68 is used for transmitting the value of the received power S1 of the information, used in turn for position estimation, to the position estimating device 56. The transmitting data generator 16 transmits the so produced position estimation information signal 68 to the transmitting circuit 18, which transmitting circuit 18 then converts the position estimation information signal 68 into the radio signal 24 to transmit the resulting radio signal over transmitter/receiver antenna 64.

The operation of the position estimation system 10 of the present alternative embodiment will now be described. Initially, the transmitting processors 58a, 58b, . . . of the target terminal device 12 transmit the position estimation request signals from the antennas 20 of the transmitting processors 58a, 58b, . . . to all of the surrounding terminal devices. The position estimation request signals are to include the identification code proper to the target terminal device 12 and the identification codes proper to the transmitting processors 58a, 58b, . . . .

The receiving circuit 36 of the reference terminal device 14 receives the position estimation information signal to transmit the resulting information 44 to the received data processor 38. In case the received data processor 38 has verified that the received data may properly be used for position estimation, the received data processor 38 instructs the transmitting circuit 18 to generate the position estimation information signal 68. This position estimation information signal 68 is to include the identification code of the target terminal device 12 contained in the position estimation information signal received, identification codes of the transmitting processors 58a, 58b, . . . , the value of the received power S1 of the position estimation request signal received and the identification codes proper to the reference terminal devices 14. The transmitting circuit 18 converts the position estimation information signal into the radio signal 24 which is transmitted over transmitter/receiver antenna 64 to the position estimating device 56.

The position estimating device 56 collects data for each of the identification code of the target terminal device 12 contained in the position estimation information signal 68 received from the reference terminal device 14 and for each of the identification codes proper to the transmitting processors 58a, 58b, . . . . The position estimating device 56 then estimates the positions of the transmitting processors 58a, 58b, . . . in each target terminal device 12 by the same operation as described above. In this alternative embodiment, the processor performed by the position estimating device 56 is a simple parallel operation, in order that the results of estimation by the target terminal device 12 will not affect the other target terminal devices 12.

In the instant alternative embodiment, as in the above-described embodiment, there may be cases where updated estimated positions conforming to the positional relationships of the transmitting processors 58a, 58b, . . . in the process of the iterative calculations affect one another to cause non-convergence of the results of position estimation. Hence, the position estimating device 56 has the function of comparing the estimated position resulting from updating of the estimated positions to the past estimated position to correct the estimated position as necessary. Moreover, as in the previous embodiment, plural antennas 20 may be provided to the target terminal device 12 to estimate the positions of the transmitting processors 58a, 58b, . . . to detect the direction and the rotation of the terminal devices. In detecting the direction and the rotation, comparison may preferably be made to the past estimated results.

Moreover, in the present alternative embodiment, plural signals are transmitted from the different transmitting processors in one and the same target terminal device 12, that is, from substantially the same locations. It is possible for the received data processor 38 of the reference terminal device 14 to find and exploit the difference of the information derived from these signals. For example, if the difference of the information derived from the plural signals exceeds a preset value, the reference terminal device 14 may deem the data with smaller values of the received power S1 to be low in reliability and discard such data.

In carrying out position estimation, the position estimating device 56 may use together the information obtained in the past. To this end, there is provided a time measurement function in each of the received data processor 38 and the position estimating device 56 in the reference terminal device 14 of the position estimation system 10 shown in FIG. 9. By so doing, there may be added the function of holding the data acquisition timing. In using past data in the position estimation by the position estimating device 56, it is possible to change the weight for past information in dependence upon the time elapsed until the current time.

The transmitting data generator 16 or the transmission manager 60 of the target terminal device 12, shown in FIG. 8, includes a movement detector for detecting movement of the target terminal device 12. The target terminal device 12 transmits the so detected signal as the signal is included in the position estimation information signal. By having the movement information of the target terminal device 12 in the position estimation information signal, it is possible, in exploiting the past information, to change the weight for the past information in dependence upon whether or not the target terminal device 12 has been moved or on the displacement of the target terminal device.

In summary, the received data processor 38 and the position estimating device 56 in the reference terminal device 14 in the position estimation system 10 include the function of time measurement. The transmitting data generator 16 or the transmission manager 60 of the target terminal device 12 includes a movement detector. In exploiting the past information, the weight afforded to the past information is varied in dependence upon the movement or non-movement of the target terminal device 12, displacement of the target terminal device or upon the time elapsed until the current time. Moreover, the received data processor 38 holds past data and verifies the reliability of the information obtained to refrain from notifying the position estimating device 56 of the information low in reliability to improve the accuracy in position estimation.

In the present alternative embodiment, the signals from the antennas 20 are not transmitted simultaneously, thus lowering the reliability in the distance by which the respective antennas are separated from one another. Thus, in the alternative embodiment, calculations for position estimation are preferably performed as certain allowance is afforded to the distances by which the antennas used for calculations are separated from one another.

More specifically, by providing the position estimating device 56 the position of the plural target terminal devices 12 may be estimated by the sole position estimating device 56, to add to the favorable effect of the previous embodiment. Moreover, the target terminal device 12 may be reduced in circuit size, without providing position estimating devices in the target terminal device 12. The orientation or the rotation of the target terminal device 12 may be detected from the installed positions of the transmitting processors 58a, 58b, . . . in the target terminal device 12. It is noted that, in the target terminal device 12 of the present alternative embodiment, instructions for transmitting the position estimation information signals or the position estimation request signals are generated by the transmitting processors 58a, 58b, . . . . However, the present invention is not limited to this but the function of generating the instructions for transmitting the position estimation information signals or the position estimation request signals may be afforded to other components.

The above-described features of the present invention may, of course, be applied to other alternative embodiments, which will be described below.

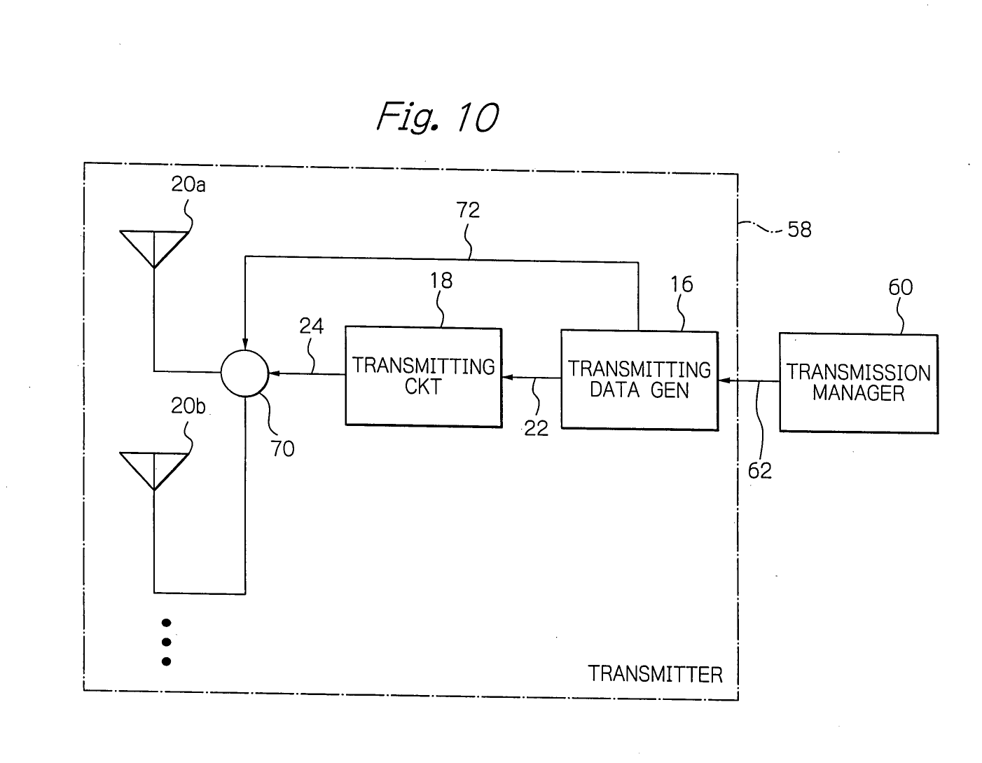

A further modification of the position estimation system 10 according to the present invention will now be described with reference to FIG. 10. The position estimation system 10 is basically the same as the configuration of FIG. 7. Another alternative embodiment is shown in FIG. 10. The transmitter 58 of the target terminal device 12 includes, in a sole transmitting processor 58a, a plural number of antennas 20a, 20b, . . . , and a selection switcher 70, which are interconnected as shown in the figure. The selection switcher 70 has the function of switching to one of the antennas 20a, 20b, . . . for transmitting the radio signals 24, generated by the transmitting circuit 18, responsive to a control signal 72 transmitted from the transmitting data generator 16.

The transmitting data generator 16 is responsive to a command from the transmission manager 60 to generate position estimation request signals to output the so generated position estimation information signals to the transmitting circuit 18. The position estimation information signal is to include an identification code proper to the target terminal device 12 and identification codes proper to the antennas 20a, 20b, . . . . The transmitting data generator 16 of the present alternative embodiment also generates a control signal 72 for switching the selection switcher 70 so that the radio signal 24 related with the identification code for the antenna contained in one of the position estimation request signals 22, generated simultaneously, will be transmitted from the antenna.

The transmitting data generator 16 is responsive to a command from the transmission manager 60 to generate a position estimation information signal, inclusive of the identification code proper to the target terminal device 12 and identification codes proper to the antennas 20a, 20b, . . . , and outputs the so generated position estimation request signals to the transmitting circuit 18. The transmitting data generator 16 also generates a control signal 72 for changing over the selection switcher 70 so that a radio signal 24 will be transmitted from the antenna related to the antenna identification code contained in the position estimation request signals 22 generated simultaneously.

The transmission manager 60 takes the processing delay in each reference terminal device 14 into account to decide on transmitting the position estimation request signal from each of the antennas 20a, 20b, . . . of the target terminal device 12 to output a transmitting command 62 to the transmitting data generator 16. The position estimation device 56 estimates the position of the transmitting antenna by transmitting the signal from the antenna to which has been switched the radio signal 24.

The position estimation system 10 estimates the respective positions of the antennas 20a, 20b, . . . of the target terminal device 12 by the operation similar to that described above. Thus, in the present alternative embodiment, the target terminal device 12 switches between the antennas 20a, 20b, . . . to transmit the radio signal to simplify the configuration further to add to the merits of the previous embodiments described above. Moreover, the target terminal device 12 may be reduced in cost to contribute significantly to longer useful life of the circuit as a result of simplifying the circuit configuration.

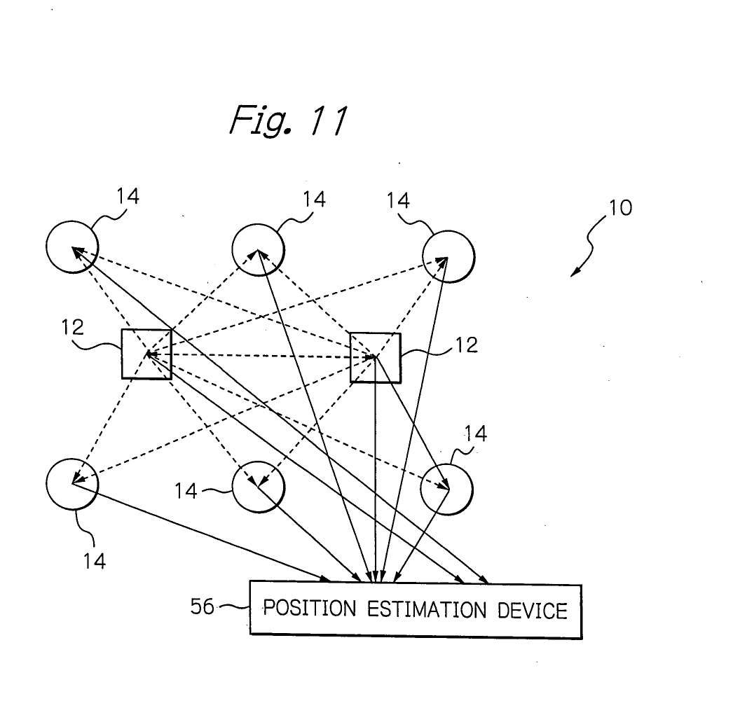

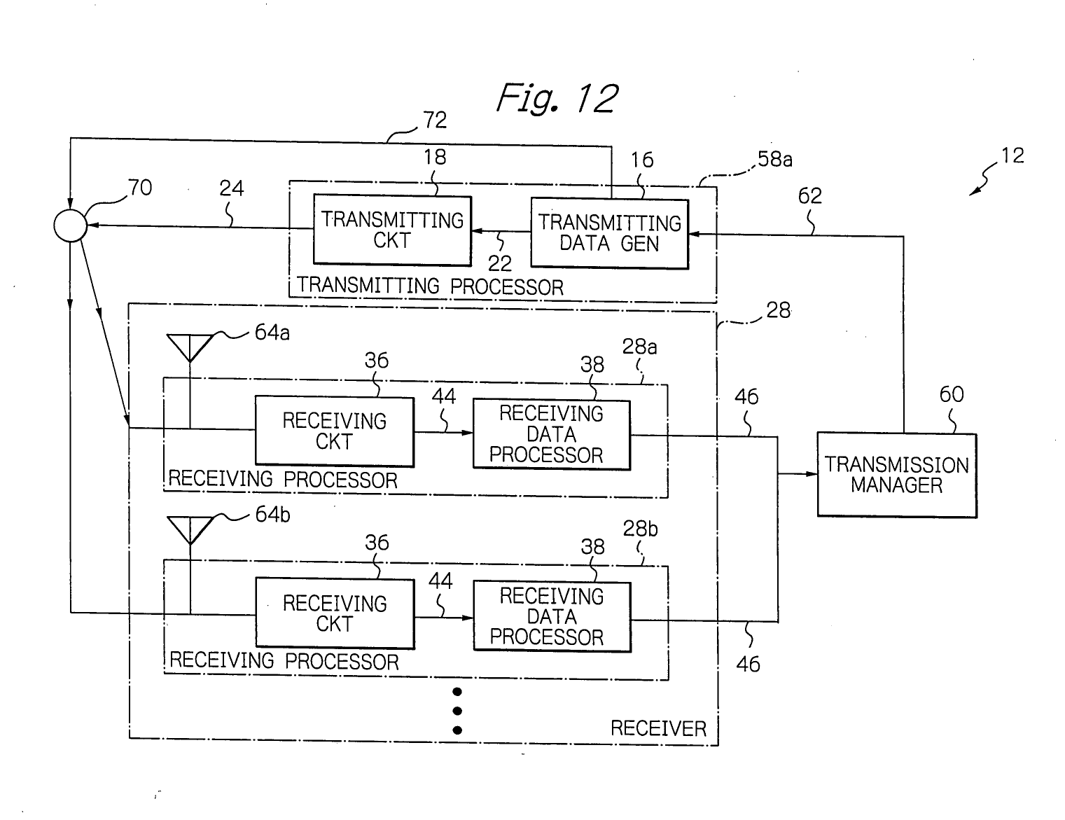

A further modification of the position estimation system 10 according to the present invention will now be described with reference to FIGS. 11 and 12. The target terminal device 12 of the position estimation system 10 of a still another alternative embodiment is a subject of position estimation, and has the function of transmitting a position estimation request signal, and the function of transmitting, on receipt of the position estimation request signal from another target terminal device 12, the information for position estimation as a position estimation information signal. The reference terminal device 14 is such a device the position of which is known from the outset and, on receipt of the position estimation request signal, transmits the information used for position estimation as a position estimation information signal.

The position estimating device 56 estimates the positions of the transmitting processors 58a, 58b, . . . from the position estimation information signal collected and ultimately estimates the positions of the plural target terminal devices 12.

The configurations of the reference terminal device 14 and the position estimating device 56 may be the same as those of the embodiments previously described.

The configuration of the target terminal device 12 of the present alternative embodiment is shown in FIG. 12. The target terminal device 12 includes a transmitting processor 58a, a transmission manager 60, a selection switcher 70 and a receiver 28, which are interconnected as depicted. The target terminal device 12 of the present alternative embodiment is featured by using transmitter/receiver antennas 64a, 64b as the receiving processors 28a, 28b, . . . of the receiver 28, and by using the antennas as transmitting antenna as well.

The operation of the position estimation system 10 of the present alternative embodiment will now be described. Initially, the target terminal device 12 transmits position estimation request signals to all of the surrounding terminal devices. The position estimation information signals include the identification code of the target terminal device 12 and the identification codes of the receiving processors 28a, 28b, . . . used for transmission. Then, upon receipt of the position estimation request signal, the reference terminal device 14 or the target terminal device 12 measures the value of the received power S1 of the position estimation request signal to transmit the position estimation information signal to the position estimating device 56. The position estimation information signal includes the value of the received power S1 of the position estimation request signal received, the identification code of the target terminal device 12, the identification codes of the receiving processors 28a, 28b, . . . , and the identification codes of the reference terminal devices 14 or the target terminal device 12, transmitting the position estimation information signal, included in the position estimation request signal received.

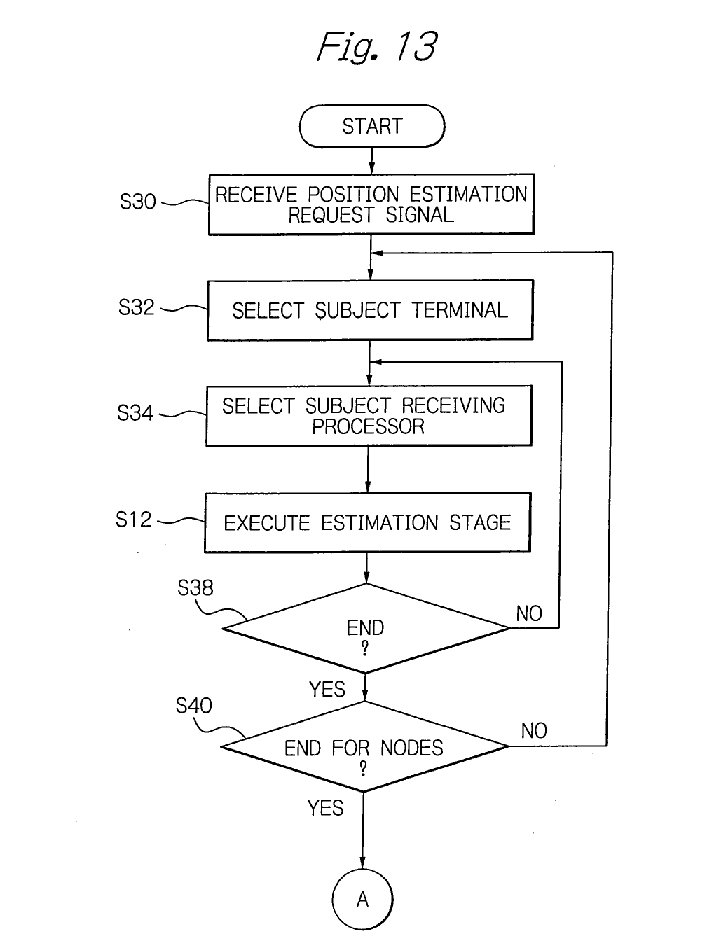

Now, referring to FIG. 13, the position estimating device 56 receives a position estimation information signal (step S30). The position estimating device 56 saves the information for each of the target terminal devices 12 which has transmitted a position estimation information signal and for each of the transmitting processor 58a used for transmission. On receipt of the position estimation information signal from the target terminal device 12 or the reference terminal device 14, the position estimating device 56 initiates position estimation. The position estimating device 56 selects an optional target terminal device 12 as a subject of position estimation (step S32).

One of the receiving processors 28a, 28b, . . . of the selected target terminal device 12, which is to be a subject for position estimation, is selected (step S34). The position estimating device 56 then executes the first estimation stage (step S12). This processing finds the first estimated position for the selected receiving processor, based only on the information of the position estimation information signal received and saved in the past. That is, the position estimating device 56 finds the estimated position of the receiving processor, as a subject for position estimation, based on the value of the received power S1 of the position estimation request signal contained in the position estimation information signal, received from each reference terminal device 14, the identification code of the target terminal device 12 contained in the position estimation information signal received, the identification codes of the receiving processors, the identification code of the reference terminal device 14 which has transmitted the position estimation information signal, and on the position of the reference terminal device 14. It is noted that the signals transmitted between the target terminal devices 12 cannot be utilized because the positions of these devices are not known. The method for acquiring the estimated position is similar to that described above with reference to the previous embodiments. However, the method described is not restrictive such that it is possible to use other suitable methods.

It is then verified whether or not the first estimation stage has been finished for all of the receiving processors 28a, 28b, . . . in the target terminal device 12 (step S36). If the processing is not finished (NO), processing reverts to the step of selecting the receiving processors 28a, 28b, . . . (to step S34). If the processing is finished (YES), processing transfers to a step of verifying whether or not the node, i.e. the target terminal device 12 has been finished (step S38).

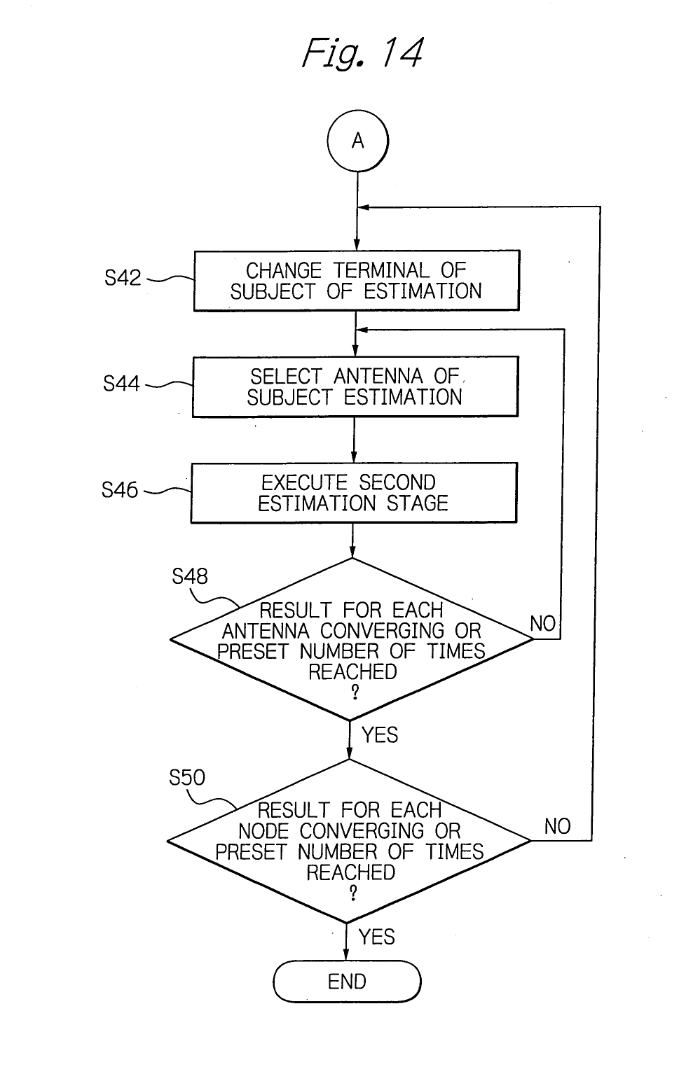

This processing for node completion decision verifies whether or not the first estimation stage has been completed for all of the target terminal devices 12 (step S38). If this processing is not finished (NO), processing reverts to the step of selecting the unprocessed target terminal device 12 (to step S32). If this processing is finished (YES), then processing transfers via a connection A, to a step of selecting the subject position estimation in shown FIG. 14 (step S40).

An optional one of the target terminal devices 12, which is to be a subject for position estimation, is selected (step S42). One of the receiving processors 28a, 28b, . . . of the selected target terminal device 12, which is to be a subject for position estimation, is selected (step S44). The receiving processors other than the selected processor are assumed to be at the first estimated positions and the second estimation stage is carried out on the selected receiving processor (step s46).

The second estimation stage estimates the second estimated position by using, in addition to the information for the first estimation stage, that is, the first estimated position, the distances (positional relationships) of the receiving processors 28a, 28b, . . . , obtained at manufacture of the target terminal device 12, and the information among the target terminal devices 12. The information among the target terminal devices 12 is the information obtained from the position estimation information signal the selected target terminal device 12 has transmitted to the position estimating device 56 on receipt of the position estimation request signal from the other target terminal devices 12. The method for acquiring the estimated position may be the same as that of the operational sequence of the second estimation stage described in the previous embodiments. However, this is not meant as being restrictive such that other suitable methods may also be used to find the estimated position.

The estimated position of the selected subject receiving processor is changed from the first estimated position to the second estimated position as a result of carrying out the second estimation stage. Since the estimated position of the selected receiving processor is used for position estimation of the other receiving processors, the change in the estimated position of the selected receiving processor affects position estimation in the other receiving processors. Thus, in case of change in the estimated position of the selected receiving processor, the positions of the other receiving processors are again estimated. That is, the second estimated position is used as the first estimated position and the second estimation stage is carried out for all of the receiving processors other than the selected receiving processor.

Then, decision is given on whether or not the second estimation stage is to be repeated further (step S48). That is, a decision is given as to whether or not the results of position estimation in all of the receiving processors 28a, 28b, . . . have converged or have reached a preset number of times of repetition. If this condition is not met (NO), processing reverts to the step of selecting a subject antenna (to step S44). If this condition is met (YES), processing transfers to a step of next decision on repetition (to step S50).

This processing of decision of repetition (step S50) gives a decision on whether or not the estimated position of the target terminal device 12 has converged or the prescribed number of times (calculating times) has been reached. If this condition is not met (NO), processing reverts to the step of selecting the subject target terminal device 12 (to step S42). If this condition is met (YES), position selection is terminated. For position estimation in the position estimating device 56, the position estimation information signal, obtained in the past, may be exploited. In giving the decision on the condition of repetition in the position estimating device 56, such a system of giving a decision as to whether or not the past information is to be used based on the difference between the present information and the past information, or such a system of using the averaged information of the past information and the present information, may be used.

Thus, in the present alternative embodiment, employing the information among the target terminal devices 12, position estimation may be made to higher accuracy even with a smaller number of the reference terminal devices 14, to add to the favorable effects of the previous embodiments. Moreover, in the previous embodiments, the number of combinations of the transmitting processors and the receiving processors, usable for position estimation, is equal to the number of the reference terminal devices×number of transmitting/receiving devices. In the present alternative embodiment, the number of combinations is equal to the number of the reference terminal devices×number of transmitting/receiving devices in the reference terminal devices+number of surrounding target terminal devices×number of transmitting/receiving devices included in the subject target terminal device×number of transmitting/receiving devices in the surrounding target terminal devices. That is, position estimation may be carried out efficiently by transmitting and receiving a sole broadcast packet to and from plural receiving processors. In the present alternative embodiment, it is the receiving processors that carry out measurement of the values of the received power or generation of the position estimation information signal. This is not meant as being restrictive and it may be other suitable component that carries out this processing.

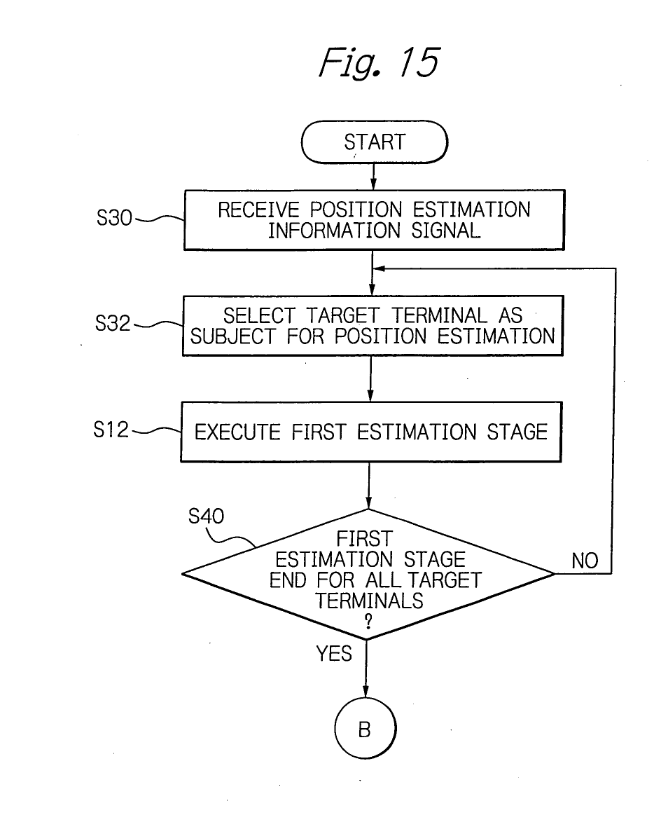

It is possible with the position estimation system 10 to use components shown in FIGS. 11 and 12 and the operational sequence shown in FIG. 5. The operations for position estimation by the position estimating device 56 in such a case (step S24) will be better understood with reference to FIG. 15.

With the structure comprising the components shown in FIGS. 11 and 12 the position estimation information signal is used in place of the position estimation request signal, and this position estimation information signal is received (step S30). The target terminal device 12, the position of which is to be estimated, is then selected (step S32). The first estimation stage is then executed (step S12). In this processing, only the information obtained from the reference terminal device 14 is exploited and the operation may be carried out in the same way as in the previous embodiments to estimate the positions of all of the receiving processors 28a, 28b, . . . of the subject target terminal device 12.

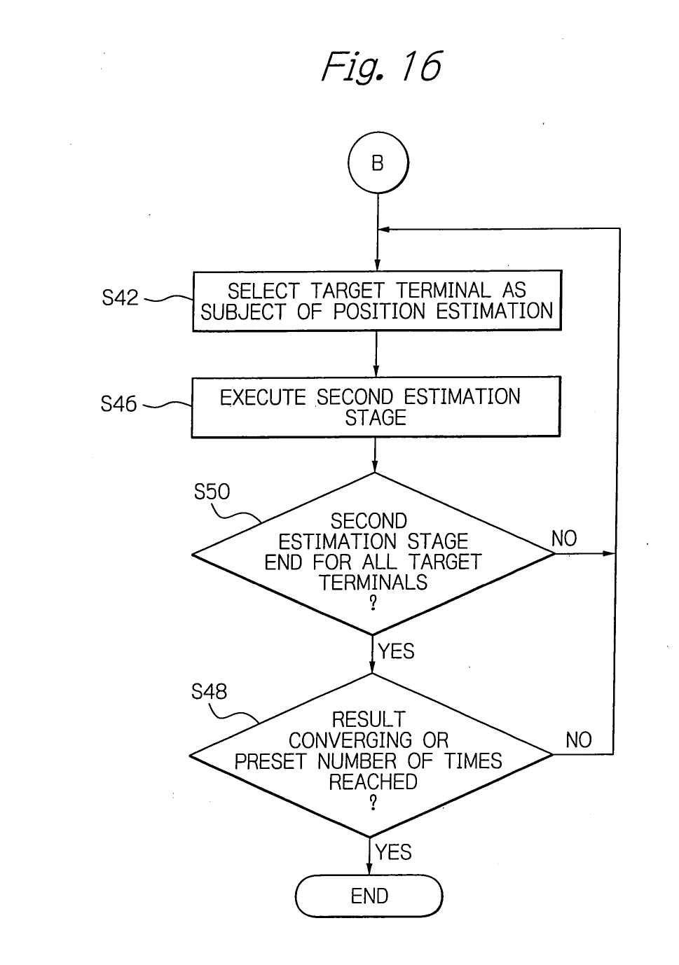

It is then verified whether or not the processing has been finished for all of the target terminal devices 12 in the first estimation stage (step S40). If the processing has not been finished (NO), processing reverts to the step of selecting a new target terminal device 12 (to step S32). If the processing has been finished (YES), processing transfers via a connection B to a step of selecting the target terminal device 12 in the second estimation stage in shown FIG. 16 (step S42).

The target terminal device 12 in the second estimation stage is selected (step S42). The second estimation stage is carried out for the selected target terminal device 12 (step S46). The positions of all of the receiving processors 28a, 28b, . . . of the subject target terminal devices 12 are estimated, using the information obtained from surrounding target terminal devices 12, and the estimated positions of the surrounding target terminal devices 12, obtained in the first estimation stage, in addition to the information obtained from the reference terminal devices 14.

It is verified whether or not processing has been finished for the second estimation stage for all of the target terminal devices 12 (step S50). If the processing has not been finished (NO), then the processing reverts to the step of selecting a new target terminal device 12 (to step S42). If the processing has been finished (YES), the condition relevant to convergence of the results of the second estimation stage or fulfillment of the condition for the prescribed number of times is verified (to step S48). It is then verified whether or not the convergence of the results or the fulfillment of the condition for the prescribed number of times in the second stage is met (step S48). If this condition is not met (NO), processing reverts to selection of a new target terminal device 12 (to step S42). If this condition is met (YES), processing comes to a close.

In the present alternative embodiment, the positions of all of the receiving processors 28a, 28b, . . . may be estimated by the information pertinent to the receiving processors 28a, 28b, . . . , and hence the calculating time may be made shorter without iterative calculations for position estimation, thus adding to the merits of the previous embodiments. Although the present invention has been described with reference to the position estimation system employing the values of the received power S1 as the information used for position estimation, this is not meant as being restrictive, but the information that may be measured by the target terminal device 12 or the reference terminal device 14 may be used without regard to the information type. The information which may be measured and which allows estimation of the distances between the terminal devices may include delay time or an angle defined between plural terminal devices.

The entire disclosure of Japanese patent application No. 2006-108784 filed on Apr. 11, 2006, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A method for position estimation for estimating a position of a plurality of target terminal devices in a wireless network, the plurality of target terminal devices being a subject for position estimation and having a function of wireless communication, the wireless network including a plurality of reference terminal devices for wireless communication and having an installed position known, said method comprising:
a first step of transmitting information on the installed position from each of the reference terminal devices;
a second step of receiving a radio signal from each of the reference terminal devices by the target terminal devices, and acquiring the information used for position estimation from the radio signals; and
a third step of estimating the position of the target terminal devices based on information for position estimation acquired in the target terminal devices, position information of the reference terminal devices and distance information on distances by which a plurality of wireless devices owned by each of the target terminal devices are separated from one another.

2. The method in accordance with claim 1, wherein said third step includes:
a fourth step of estimating the positions of all of the target terminal devices, as a first estimation stage, using the acquired information, the position information and the distance information; and
a fifth step of estimating the positions of the target terminal devices, as a second estimation stage, based on the information on the estimated positions, acquired in said first estimation stage, the position information and the distance information;
the position estimation in said second estimation stage setting a position showing a highest value obtained as being an estimated position.

3. The method in accordance with claim 1, further comprising:
formulating an evaluation function specifying the positions of radio antennas owned by the target terminal devices, based at least on the acquired information from the radio signals, the position information and the distance information;
finding points corresponding to extreme values of the evaluation function to find estimated positions of the radio antennas; and
estimating the positions of the target terminal devices based on the estimated positions.

4. A method for position estimation for estimating a position of a plurality of target terminal devices in a wireless network, the plurality of target terminal devices being a subject for position estimation and having a function of wireless communication, the wireless network including a plurality of reference terminal devices for wireless communication and having an installed position known, said method comprising:
a first step of transmitting a information from each of the target terminal devices;
a second step of receiving the information from the target terminal devices at each of the reference terminal devices and transmitting a radio signal including information produced responsive to the received information from each of the reference terminal devices to the target terminal devices; and
a third step of estimating the position of the target terminal devices based on information for position estimation acquired from the radio signals received by the target terminal devices, the position of the reference terminal devices and distance information on a distance by which a plurality of radio devices owned by the target terminal devices are separated from one another.

5. The method in accordance with claim 4, wherein said third step includes:
a fourth step of estimating the positions of all of the target terminal devices, as a first estimation stage, using the acquired information, the position information and the distance information; and
a fifth step of estimating the positions of the target terminal devices, as a second estimation stage, based on the information on the estimated positions, acquired in said first estimation stage, the position information and the distance information;
the position estimation in said second estimation stage setting a position showing a highest value obtained as being an estimated position.

6. The method in accordance with claim 5, further comprising:
formulating an evaluation function specifying the positions of radio antennas owned by the target terminal devices, based at least on the acquired information from the radio signals, the position information and the distance information;
finding points corresponding to extreme values of the evaluation function to find estimated positions of the radio antennas; and
estimating the positions of the target terminal devices based on the estimated positions.

7. A position estimation system comprising:
a target terminal device having a plurality of radio devices, a distance of which from one another is known;
a plurality of reference terminal devices arranged at known positions, said reference terminal devices transmitting and receiving radio signals to and from said target terminal device; and
a position estimator for estimating the position of said target terminal device, based on the radio signal, the position of said reference terminal devices and a distance by which said radio devices are separated from one another;
said position estimator acquiring information for position estimation from the radio signals;
said position estimator finding an estimated position of said radio devices based at least on the information for position estimation acquired, the position of said reference terminal devices and on the positional relationship of said radio devices inclusive of the distance by which the radio devices are separated from one another;
said position estimator estimating the position of said target terminal device based on the estimated position of said radio devices.

8. The system in accordance with claim 7, further including an additional target terminal device substantially equivalent to said target terminal device;
said radio devices of said target terminal devices transmitting a position estimation request signal containing information on an identification code proper to said target terminal devices and information on an identification code proper to said radio devices, said radio devices receiving the position estimation request signal transmitted from said target terminal devices other than an own target terminal device;
said target terminal devices measuring information for position estimation from the position estimation request signal received by said radio devices, and transmitting a position estimation information signal including the information for position estimation measured, the identification code proper to said other target terminal devices, included in the position estimation request signals, the information on the identification code proper to said radio devices and the information on the identification code proper to said target terminal devices which have received the position estimation request signal;
said reference terminal devices receiving the position estimation request signal transmitted from said radio devices of said target terminal devices, measuring the information for position estimation from the position estimation request signal received, and transmitting a position estimation information signal including the information for position estimation measured, the information on identification code of said target terminal devices included in the position estimation request signal and on the identification code proper to said radio devices, and the information of identification code proper to the reference terminal devices which have received the position estimation request signal;
said position estimator receiving the position estimation information signal transmitted from said target terminal devices and said reference terminal devices and finding an estimated position of said radio devices based on the information for position estimation included in the position estimation information signal received from said reference terminal devices, the information including the identification codes proper to said target terminal devices and on the identification code proper to said radio devices, the information on the identification code proper to said reference terminal devices, the position of said reference terminal devices, the distance by which said radio devices are separated from one another, and an angle which the radio devices make with one another, said position estimator estimating the position of said target terminal devices based on estimated position of said radio devices.

9. The system in accordance with claim 7, wherein each of said radio devices in each of said target terminal devices includes a plurality of antennas transmitting and receiving the radio signal;
a selection switcher connected to said antennas; and
a wireless circuit connected to one of said antennas by said selection switcher.

10. The system in accordance with claim 7, wherein one of said target terminal device and said reference terminal device measures a value of received power of the radio signal and sets information on the value of the received power measured as the information used for position estimation.

11. A position estimation system comprising:
a target terminal device having a plurality of radio devices, a distance of which from one another is known;
a plurality of reference terminal devices arranged at a known position for transmitting and receiving a radio signal to and from said target terminal device; and
a position estimator for estimating a position of said target terminal device, based on the radio signal, the position of said reference terminal devices and the distance by which said radio devices are separated from one another;
said position estimator acquiring information for position estimation from the radio signal and finding a first estimated position information in each of said radio devices based at least on information for position estimation acquired and on the position of said reference terminal devices;
said position estimator finding a second estimated position information in said radio devices based at least on the first estimated position information in each radio device, the distance by which said radio devices are separated from one another, the information for position estimation, acquired form the radio signal, and the position of said reference terminal devices;
said position estimator estimating the position of said target terminal device based on the second estimated position information in said radio devices.

12. The system in accordance with claim 11, wherein each of said reference terminal devices transmits a position estimation request signal, inclusive of information on an identification code proper to said reference terminal device;
said radio devices in said target terminal device receiving the position estimation request signal transmitted from said reference terminal devices;
said target terminal device having said position estimator installed therein and measuring information for position estimation from the position estimation request signal received by said radio devices, and supplying the information for position estimation measured, information on an identification code proper to said reference terminal devices, included in the position estimation request signal, and the information on an identification code proper to the radio devices which have received the position estimation request signal, to said position estimator;
said position estimator finding a first estimated position of said radio devices, based on the information for position estimation, the information on the identification code proper to said reference terminal devices, the information on the identification code proper to said radio devices and the position of said reference terminal devices;
said position estimator finding a second estimated position of said radio devices, based on the first estimated position in said radio devices, the distance by which said radio devices are separated from one another, the information for position estimation, the information on the identification code proper to said reference terminal devices, the information on the identification code proper to said radio devices and the position of said reference terminal devices;
said position estimator estimating the position of said target terminal device based on the second estimated position of said radio devices.

13. The system in accordance with claim 11, wherein said radio devices in said target terminal device transmits a position estimation request signal inclusive of the information on the identification code proper to said radio devices;
said reference terminal device receiving the position estimation request signal transmitted from said radio devices, measuring the information for position estimation from the position estimation request signal received, and transmitting a position estimation information signal inclusive of the information for position estimation measured, the information on the identification code proper to said radio devices, included in the position estimation request signal, and the information on the identification code proper to said reference terminal devices;
said position estimator receiving the position estimation information signal transmitted from said reference terminal devices and finding the first estimated position of said radio devices, based on the information for position estimation, included in the position estimation information signal received, the information on the identification code proper to said radio devices, the information on the identification code proper to said reference terminal devices, and the position of said reference terminal devices;
said position estimator finding the second estimated position of said radio devices, based on the first estimated position of said radio devices, the distance by which said radio devices are separated from one another, the information for position estimation, the information on the identification code proper to said reference terminal devices, the information on the identification code proper to said radio devices and the position of said reference terminal devices;
said position estimator estimating the position of said target terminal device based on the second estimated position of said radio devices.

14. The system in accordance with claim 11, further comprising an additional target terminal substantially equivalent to said target terminal device;
said radio devices of said target terminal devices a transmitting position estimation request signal including the information of the identification code proper to said target terminal devices and the information of the identification code proper to said radio devices;
said radio devices receiving the position estimation request signal transmitted from the target terminal devices other than an own target terminal device;
said target terminal devices measuring the information for position estimation from the position estimation request signal received by said radio devices, and transmitting a position estimation information signal including the information for position estimation measured, the information including the identification code proper to said other target terminal devices, included in the position estimation request signal, the information on the identification code proper to said radio devices, and the information on the identification code proper to said target terminal devices which have received the position estimation request signal;
said reference terminal devices receiving the position estimation request signal transmitted from said radio devices of said target terminal devices, measuring information for position estimation from the position estimation request signal received, and transmitting a position estimation information signal, including the information for position estimation, measured, the information on identification code of said target terminal devices, included in the position estimation request signal, and on the identification code proper to said radio devices, and the information of identification code proper to the reference terminal devices which have received the position estimation request signal;
said position estimator receiving the position estimation information signal transmitted from said target terminal devices and said reference terminal devices, and finding a first estimated position of said radio devices, based on the information for position estimation, included in the position estimation information signal received from said reference terminal devices, the information on the identification code proper to said target terminal devices and identification codes proper to said radio devices, the information on the identification code proper to said reference terminal device, and the position of said reference terminal devices;
said position estimator finding a second estimated position of said radio devices, based on the information for position estimation, included in the position estimation information signal, received from said target terminal devices and said reference terminal devices, the information on identification code proper to said target terminal devices which have transmitted the position estimation request signal, and the identification code proper to said radio devices, the information on the identification code proper to said reference terminal devices, the first estimated position of said radio devices, the distance by which said radio devices are separated from one another, and the position of said reference terminal device;
said position estimator estimating the position of said target terminal devices based on the second estimated position of said radio devices.

15. The system in accordance with claim 11, wherein said position estimator is responsive to a request of the second estimated position of said radio device to set the second estimated position of said radio device as a first estimated position to find again the second estimated positions of the other radio devices.

16. The system in accordance with claim 11, wherein each of said radio devices in each of said target terminal devices includes a plurality of antennas for transmitting and receiving the radio signal;
a selection switcher connected to said antennas; and
a wireless section connected to one of said antennas by said selection switcher.

17. The system in accordance with claim 11, wherein one of said target terminal device and said reference terminal device measures a value of received power of the radio signal and sets information on the value of the received power measured as the information used for position estimation.

18. The system in accordance with claim 17, wherein in case the value of the received power of the radio signal is larger than a predetermined value, said position estimator sets information on the value of the received power as the information used for position estimation.

19. The system in accordance with claim 17, wherein said target terminal device includes a movement detector for detecting a movement of said target terminal device as a subject of position estimation, information on the movement of said target terminal device being included in the position estimation information signal;
said position estimator storing the information included in the position estimation information signal, responsive to reception of the position estimation information signal, selecting the information thus stored based on the information on the movement of said target terminal device and finding the second estimated position in said radio devices using the selected information.

20. The system in accordance with claim 11, wherein said position estimator stores information included in the position estimation information signal, responsive to reception of the position estimation information signal, selects the information thus stored based on time elapsed as from receipt of the position estimation information signal and finds the second estimated position in said radio devices using the selected information.

21. The system in accordance with claim 11, wherein said position estimator has information on a relative position of said radio devices in said target terminal device with respect to said target terminal device, said position estimator estimating a direction of said target terminal device based on the information on the relative position and on the second estimated position in said radio devices.

22. The system in accordance with claim 21, wherein said position estimator stores the information included in the position estimation information signal, responsive to reception of the position estimation information signal, and estimates rotation of said target terminal device based on the second estimated position in said radio devices and the stored information.

23. The system in accordance with claim 12, wherein said target terminal device is a wireless communication terminal device.
